(19) United States
(12) Patent Application Publication
(10) Pub. No.: US 2026/0229437 A1
(43) Pub. Date: Aug. 6, 2026

(54) CIRCUIT PROTECTION COMPONENT CAPABLE OF WITHSTANDING HIGH CURRENT

(71) Applicant: CONQUER ELECTRONICS CO., LTD., New Taipei City (TW)

(72) Inventors: Hung-Chih CHIU, New Taipei City (TW); Po-Shuo CHIU, New Taipei City (TW)

(21) Appl. No.: 19/252,102

(22) Filed: Jun. 27, 2025

(30) Foreign Application Priority Data
Feb. 5, 2025 (TW) 114104215

(51) Int. Cl. H01H 85/055; H01H 85/165

(52) U.S. Cl. CPC H01H 85/055; H01H 85/165

(57) ABSTRACT

A circuit protection component capable of withstanding high current includes a conductive fuse element installed within a housing. The conductive fuse element has a fuse sheet and two conductive tabs. The fuse sheet is positioned between the conductive tabs and is thinner than the conductive tabs. The fuse sheet includes two fuse portions. The use of relatively thick conductive tabs increases the cross-sectional area, resulting in lower electrical resistance. Additionally, the dual fuse portion design allows current to split between paths, thereby enhancing the component's ability to withstand higher current. Overall, this configuration enables the circuit protection component of the present invention to effectively handle large currents.

### CROSS-REFERENCE TO RELATED APPLICATIONS

This application is based upon and claims priority under 35 U.S.C. 119 from Taiwan Patent Application No. 114104215 filed on Feb. 5, 2025, which is hereby specifically incorporated herein by this reference thereto.

### BACKGROUND OF THE INVENTION

### 1. Field of the Invention

The present invention relates to a protective component, specifically an electronic component used in circuits that provides circuit protection by fusing in response to overcurrent conditions.

### 2. Description of the Prior Arts

In response to technological advancements, many high-current devices have emerged, such as energy storage systems used in conjunction with renewable energy sources or battery packs for electric vehicles, which require rapid charging or discharging when needed. Another example is artificial intelligence (AI) computing equipment, which consumes high currents during high-speed operations. Existing surface-mount circuit protection components are mostly limited to withstanding currents of up to 100 amperes. However, the aforementioned high-current devices often require 150 amperes or even higher. Therefore, the development of circuit protection components capable of withstanding high current has become an urgent necessity.

### SUMMARY

To overcome the shortcomings, the present invention provides a circuit protection component capable of withstanding high current to mitigate or to obviate the aforementioned problems.

A circuit protection component capable of withstanding high current includes a conductive fuse element installed within a housing. The conductive fuse element has a fuse sheet and two conductive tabs. The fuse sheet is positioned between the conductive tabs and is thinner than the conductive tabs. The fuse sheet includes two fuse portions. The use of relatively thick conductive tabs increases the cross-sectional area, resulting in lower electrical resistance. Additionally, the dual fuse portion design allows current to split between paths, thereby enhancing the component's ability to withstand higher current. Overall, this configuration enables the circuit protection component of the present invention to effectively handle large currents.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a circuit protection component in accordance with the present invention;

FIG. 2 is an exploded perspective view of the circuit protection component in FIG. 1 without an encapsulating compound;

FIG. 3 is a side view in partial section of the circuit protection component in FIG. 1;

FIG. 4 is a top view of the circuit protection component in FIG. 1 without the encapsulating compound;

FIG. 5 is a perspective view of a first embodiment of a conductive fuse element of the circuit protection component in FIG. 1;

FIG. 6 is a perspective view of a second embodiment of a circuit protection component in accordance with the present invention;

FIG. 7 is a perspective view of a third embodiment of a circuit protection component in accordance with the present invention;

FIG. 8 is a side view in partial section of a fourth embodiment of a circuit protection component in accordance with the present invention; and

FIG. 9 an operational a top view of the circuit protection component in FIG. 1 without the encapsulating compound, shown a part of the conductive fuse element is melt.

### DETAILED DESCRIPTION OF THE EMBODIMENTS

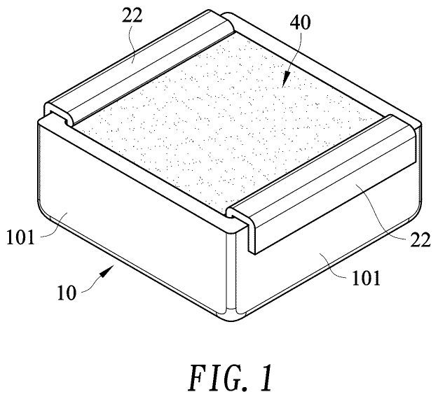

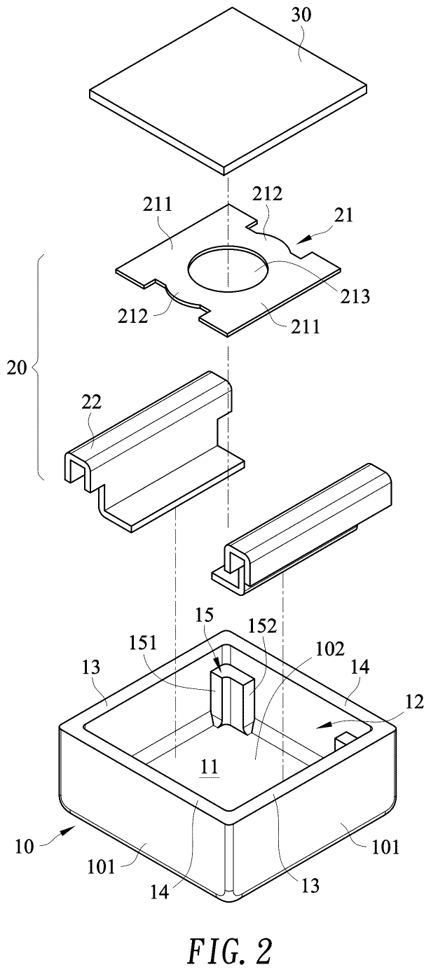

With reference to FIGS. 1 and 2, a circuit protection component in accordance with the present invention comprises a housing 10, a conductive fuse element 20, a cover 30, and an encapsulating compound 40.

The housing 10 includes an internal space 11 and an opening 12. In one embodiment, the housing 10 comprises four side walls 101 and a bottom wall 102. The four side walls 101 extend vertically from the four edges of the bottom wall 102, thereby enclosing the internal space 11 and forming the opening 12 opposite the bottom wall 102. In one embodiment, the housing 10 includes two opposing first side edges 13 and two opposing second side edges 14. The first side edges 13 are connected to the adjacent second side edges 14. Within the internal space 11, four positioning blocks 15 are arranged. Each positioning block 15 is located at one of the four corners of the internal space 11. That is, each positioning block 15 is positioned at the junction between an adjacent first side edge 13 and second side edge 14. Each positioning block 15 includes a short wall 151 and a long wall 152, with the short wall 151 arranged along the corresponding first side edge 13 and the long wall 152 arranged along the corresponding second side edge 14.

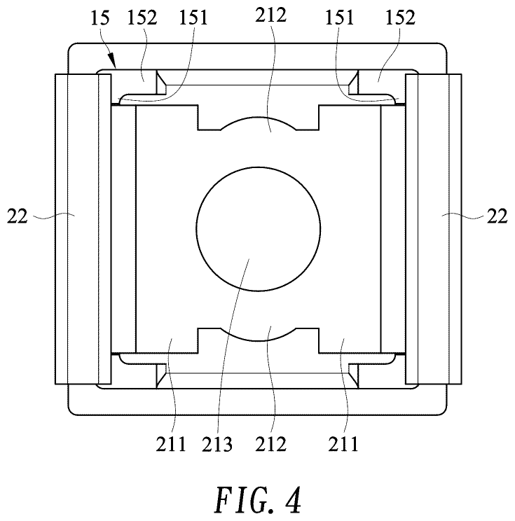

With reference to FIGS. 2 and 4, the conductive fuse element 20 is mounted through the opening 12 of the housing 10 and includes a fuse sheet 21 and two conductive tabs 22. The fuse sheet 21 is connected between the conductive tabs 22. The fuse sheet 21 is thinner than the conductive tabs 22. The fuse sheet 21 is disposed within the internal space 11 of the housing 10, while the conductive tabs 22 extend from the internal space 11 through the opening 12 to the outside of the housing 10. The fuse sheet 21 includes two connection portions 211 and two fuse portions 212. The connection portions 211 are respectively connected to the conductive tabs 22. The fuse portions 212 bridge between the connection portions 211, such that the fuse portions 212 and the connection portions 211 define a central hole 213. In one embodiment, each conductive tab 22 is positioned against and extends along a corresponding sidewall 101 of the housing 10 to the outside.

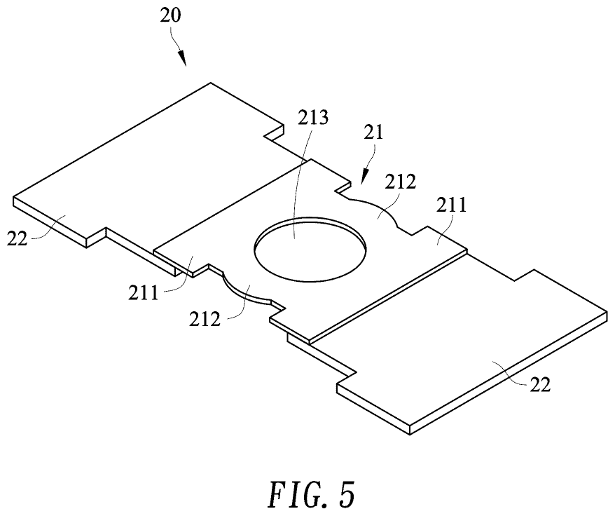

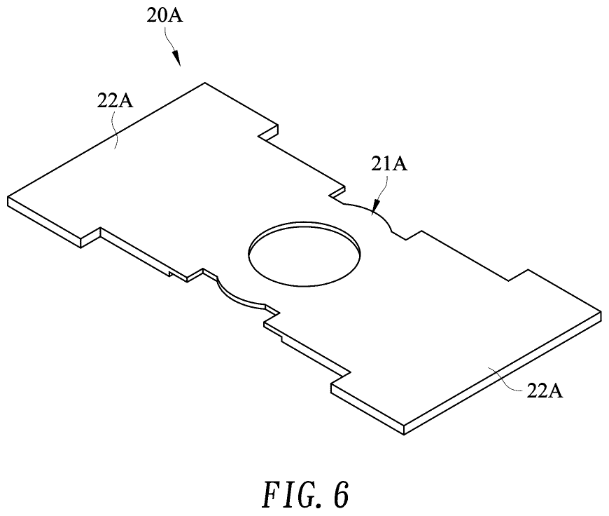

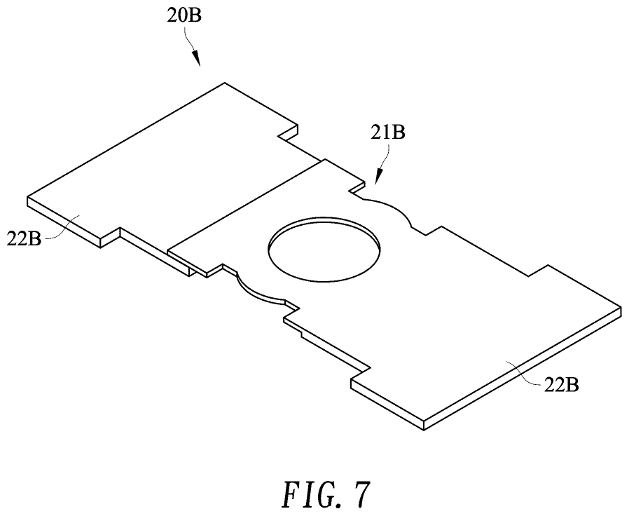

In one embodiment (as shown in FIG. 5), the fuse sheet 21 and the conductive tabs 22 are separately formed and connected to each other (e.g., by welding). In another embodiment (as shown in FIG. 6), the fuse sheet 21A and conductive tabs 22A of the conductive fuse element 20A are integrally formed. In yet another embodiment (as shown in FIG. 7), one end of the fuse sheet 21B of the conductive fuse element 20B is integrally formed with one of the conductive tabs 22B, and the other end is connected (e.g., by welding) to the other conductive tab 22B.

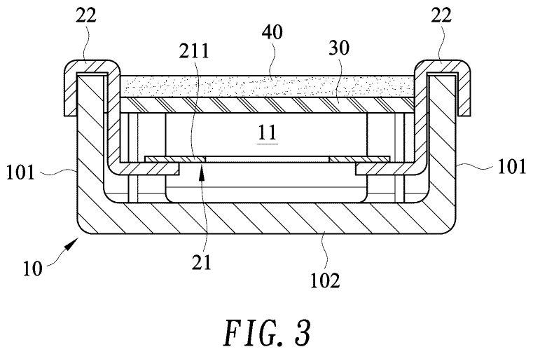

In one embodiment, each conductive tab 22 corresponds to two of the positioning blocks 151. A part of the edge of each conductive tab 22 abuts between the short walls 151 of the corresponding positioning blocks 15. This allows for easier alignment of the conductive fuse element 20 during assembly, as the edge of each conductive tab 22 can be aligned between the short walls 151 of the positioning blocks 15, facilitating insertion of part of the conductive fuse element 20 into the internal space 11 of the housing 10 and improving assembly efficiency. Typically, the conductive fuse element 20 is in a flat state (as shown in FIG. 5) prior to assembly. During assembly, the conductive tabs 22 are bent into the configuration shown in FIGS. 1 to 4. In one embodiment, the conductive fuse element 20 is made of metals such as silver, copper, nickel, tin, aluminum, zinc, or alloys thereof. In another embodiment, the material is silver or copper. In one embodiment, the fuse sheet 21 and the conductive tabs 22 are made of different materials, while in another embodiment, they are made of the same material.

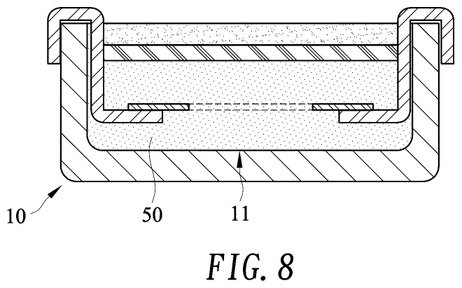

The cover 30 is fitted over the opening 12 of the housing 10, thereby enclosing the fuse sheet 21 of the conductive fuse element 20 within the internal space 11 of the housing 10. In one embodiment, the cover 30 is made of ceramic or plastic material. In one embodiment (as shown in FIG. 8), an explosion-proof material 50 is first filled into the internal space 11 before the cover 30 is applied. The explosion-proof material 50 is used to suppress any potential arc that may be caused by the intense heat generated when the fuse sheet 21 begins to melt due to excessive current. In one embodiment, the explosion-proof material 50 is made of quartz sand, arc-suppressing sand, ceramic sand, glass fiber, or flame retardants. The flame retardants may include materials such as melamine, magnesium hydroxide, or aluminum hydroxide.

The encapsulating compound 40 is applied over the cover 30. In one embodiment, the encapsulating compound 40 is made of materials such as silicone, epoxy, nylon, or engineering plastics.

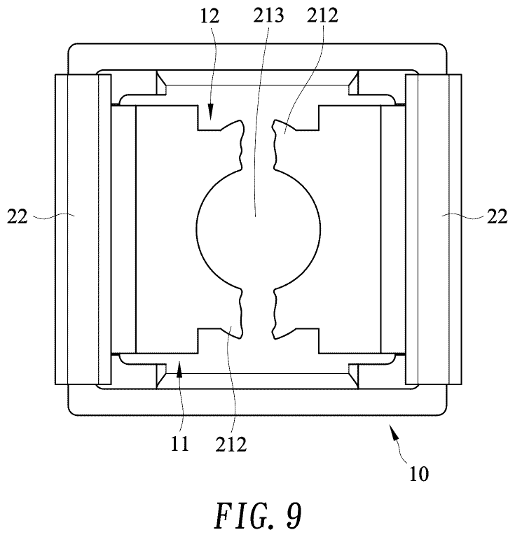

With referenced to FIGS. 4 and 9, during operation, the circuit protection component as described is connected in series at the required position within a circuit and electrically connected to corresponding electronic components via the conductive tabs 22. When a current exceeding the load passes through, the fuse portions 212 melt and break the circuit, thereby achieving circuit protection. Since the conductive tabs 22 are relatively thick, they have a larger cross-sectional area, which effectively reduces resistance. Additionally, the fuse sheet 21 is designed with two fuse portions 212, allowing the current to split and flow through multiple paths. Overall, this design enables the circuit protection component of the present invention to withstand higher current levels.

In summary, the advantages of the circuit protection component as described lie in the use of relatively thick conductive tabs to increase the cross-sectional area, thereby reducing resistance and enabling the circuit protection component to withstand higher current overall. Furthermore, the fuse sheet includes two connection portions and two fuse portions. The connection portions are respectively connected to the corresponding conductive tabs, while the fuse portions bridge between the connection portions, forming a central hole surrounded by the fuse and connection portions. The design of the two fuse portions in the fuse sheet allows current to split as it passes through the conductive fuse element, further enhancing the current-handling capability of the circuit protection component.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A circuit protection component comprising:
a housing having an opening and an internal space;
a conductive fuse element disposed through the opening of the housing and having
two conductive tabs protruding from the internal space through the opening of the housing; and
a fuse sheet connected between the conductive tabs thinner than the conductive tabs and positioned within the internal space of the housing;
a cover covering the opening of the housing; and
an encapsulating compound applied over the cover.

2. The circuit protection component as claimed in claim 1, wherein the fuse sheet has
two connection portions respectively connected to the conductive tabs; and
two fuse portions bridging between the connection portions, such that the fuse portions and the connection portions define a central hole.

3. The circuit protection component as claimed in claim 1, wherein the fuse sheet and the conductive tabs are separately formed and connect to each other.

4. The circuit protection component as claimed in claim 2, wherein the fuse sheet and the conductive tabs are separately formed and connect to each other.

5. The circuit protection component as claimed in claim 1, wherein the fuse sheet and the conductive tabs are integrally formed.

6. The circuit protection component as claimed in claim 2, wherein the fuse sheet and the conductive tabs are integrally formed.

7. The circuit protection component as claimed in claim 1, wherein one end of the fuse sheet of the conductive fuse element is integrally formed with one of the conductive tabs, and the other end is connected to the other conductive tab.

8. The circuit protection component as claimed in claim 2, wherein one end of the fuse sheet of the conductive fuse element is integrally formed with one of the conductive tabs, and the other end is connected to the other conductive tab.

9. The circuit protection component as claimed in claim 1, wherein the fuse sheet and the conductive tabs are made by the same material.

10. The circuit protection component as claimed in claim 2, wherein the fuse sheet and the conductive tabs are made by the same material.

11. The circuit protection component as claimed in claim 1, wherein the fuse sheet and the conductive tabs are made by different materials.

12. The circuit protection component as claimed in claim 2, wherein the fuse sheet and the conductive tabs are made by different materials.

13. The circuit protection component as claimed in claim 1, wherein the housing comprises
a bottom wall; and
four side walls extending vertically from four edges of the bottom wall, thereby enclosing the internal space and forming the opening opposite the bottom wall.

14. The circuit protection component as claimed in claim 2, wherein the housing comprises
a bottom wall; and
four side walls extending vertically from four edges of the bottom wall, thereby enclosing the internal space and forming the opening opposite the bottom wall.

15. The circuit protection component as claimed in claim 13, wherein
the housing comprises
two opposing first side edges and two opposing second side edges, wherein the first side edges are connected to the adjacent second side edges; and
four positioning blocks, and each positioning block positioned at the junction between adjacent first side edge and second side edge and having
a short wall arranged along a corresponding one of the first side edges; and
a long wall arranged along a corresponding one of the second side edges; and
each conductive tab corresponds to two of the positioning blocks and part of an edge of each conductive tab is positioned abuts between the short walls of the corresponding positioning blocks.

16. The circuit protection component as claimed in claim 14, wherein the housing comprises
two opposing first side edges and two opposing second side edges, wherein the first side edges are connected to the adjacent second side edges; and
four positioning blocks, and each positioning block positioned at the junction between adjacent first side edge and second side edge and having
a short wall arranged along a corresponding one of the first side edges; and
a long wall arranged along a corresponding one of the second side edges; and
each conductive tab corresponds to two of the positioning blocks and part of an edge of each conductive tab is positioned abuts between the short walls of the corresponding positioning blocks.

17. The circuit protection component as claimed in claim 13, wherein each conductive tab is positioned against and extends along a corresponding sidewall of the housing 10.

18. The circuit protection component as claimed in claim 15, wherein each conductive tab is positioned against and extends along a corresponding sidewall of the housing 10.

19. The circuit protection component as claimed in claim 1, wherein an explosion-proof material is filled into the internal space.

20. The circuit protection component as claimed in claim 2, wherein an explosion-proof material is filled into the internal space.
